(19) United States
(12) Patent Application Publication
(10) Pub. No.: US 2010/0201629 A1
(43) Pub. Date: Aug. 12, 2010

(54) System for inputting different language characters based on virtual keyboard and method thereof

(75) Inventors: Chaucer Chiu, Taipei (TW); Xiao Hui Shao, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/320,851

(22) Filed: Feb. 6, 2009

(51) Int. Cl. G06F 3/03

(52) U.S. Cl. 345/171

(57) ABSTRACT

A system for inputting different language characters based on a virtual keyboard and a method thereof, by displaying a virtual keyboard comprising characters of a second language after receiving a trigger signal produced by a user in an input environment for a first language, and providing for the user to input the characters of the second language based on the virtual keyboard, an existed problem that it is not possible to input characters of other languages in the input environment for the first language can be solved, thereby achieving a technical effect of enabling a user to input characters of other languages more rapidly.

### BACKGROUND OF THE INVENTION

1. Field of Invention

The present invention relates to an input system and a method thereof, and more particularly, to a system for inputting different language characters based on a virtual keyboard and a method thereof.

2. Related Art

In current digital devices, inputting data with a keyboard is the most widespread way, and is also the most dominant input mode. There gradually developed a mature general QWERTY Keyboard internationally, which includes thereon such keys as 10 Arabic numbers, 26 English letters, commonly used punctuations, as well as many specific functional keys.

However, it is not so convenient for people in non-English countries to operate and use the general QWERTY Keyboard, therefore, some users research and develop input methods corresponding to languages of various countries, enabling groups of different languages to input and edit their familiar texts in digital devices. The users may switch the input methods or keyboard arrangements according to instructions of operating system executed on the digital device in order to input different languages.

When a user inputs texts in a different language, there must be installed in the digital device operating system in advance an input method for the language. If there is not installed the input method for the language in the operating system, the user is unable to input characters of the language, so that the user can not input the texts of the language smoothly. But in certain circumstances, the user needs to input certain characters, for example, original text representing somebody's name, because the user has not installed the input method for the language that he/she does not understand, the user will need to install the input method for the language that he/she does not understand for very accidental situations, and need to study the use method for the input method, this will create additional puzzles to the user.

To sum up, it can be known that there has been a problem in prior art for a long time that it is not possible to input characters of other languages in an input environment for a first language. Therefore, it is necessary to present an improved technical solution to solve such a problem.

### SUMMARY OF THE INVENTION

In view of the problem existed in prior art that it is not possible for an input method to input characters of other languages in an input environment for a first language, the present invention discloses a system for inputting different language characters based on a virtual keyboard and a method thereof, in which:

The system for inputting different language characters based on a virtual keyboard disclosed by the present invention includes a store module adapted to store characters and various character codes corresponding to the various characters respectively, where the characters belong to a second language; a user input module adapted to receive a trigger signal input by the user; a judge module adapted to judge a target language as the second language based on a language setting parameter after the user input module receives the trigger signal; a display module adapted to display a virtual keyboard containing the characters for the user input module to provide for the user to input the characters based on the virtual keyboard, where the characters belong to the second language; a character input module adapted to input the character codes corresponding to the characters. It solves the problem existed in prior art by displaying the virtual keyboard containing the characters of the second language by the display module after the user input module receives the trigger signal input by the user when the user is using an input method for the first language, and providing for the user to input the characters of the second language based on the virtual keyboard with the user input module.

The method for inputting different language characters based on a virtual keyboard disclosed by the present invention includes the following steps: storing characters belonging to a second language and various character codes corresponding to various characters respectively; judging a target language as the second language based on a language setting parameter after receiving a trigger signal; displaying a virtual keyboard containing the characters belonging to the second language; inputting the characters based on the virtual keyboard; inputting the character codes corresponding to the characters. It solves the problem existed in prior art by displaying the virtual keyboard containing the characters of the second language after receiving the trigger signal input by the user when the user uses an input method for the first language, and providing for the user to input the characters of the second language based on the virtual keyboard.

The system and method disclosed by the present invention are as above, which is different from the prior art in that, the present invention displays the virtual keyboard containing the characters of the second language after receiving the trigger signal produced by an input behavior of the user in an input environment for the first language, and provides for the user to input the characters of the second language based on the virtual keyboard. With the above technical solution, the present invention can achieve a technical effect of enabling the user to input characters of other languages rapidly.

The first language mentioned in the present invention refers to a language that a user can input when performing an input behavior without using the present invention, i.e., a language that the user can input by using the input methods that he/she has installed, including, but not limited to, Chinese, English and so on.

The second language mentioned in the present invention refers to a language to which characters that the user can not input by using currently used input methods belong when the user performs an input behavior without using the present invention. Generally, the user usually has not installed the input methods for the second language, but the present invention is not so limited.

In most cases, the second language is different from the first language. But if partial characters of the first language can not be input by the input method for inputting the first language, in this case, in order to provide for the user to input the partial characters of the first language that can not be input by the input method he/she uses, the present invention provides that the second language and the first language by which the user inputs characters belong to the same language, i.e., when the input method that the user uses is unable to input some specific characters of the first language, the present invention may provide for the user to input the characters that can not be input, at this time, the second language mentioned by the present invention will be the same as the first language. For example, when the first language is English, because the input method for English (the first language) is unable to input characters representing English phonetic symbols, in order to input English phonetic symbols, the second language mentioned by the present invention may also be English, thereby providing for the user to input the characters representing English phonetic symbols through the present invention.

### BRIEF DESCRIPTION OF THE DRAWINGS

The present invention will become more fully understood from the detailed description given herein below for illustration only, and thus are not limitative of the present invention, and wherein:

FIG. 1 is an architecture diagram of a system for inputting different language characters based on a virtual keyboard according to the present invention.

FIG. 2 is a schematic view of a character code index table according to an embodiment of the present invention.

FIG. 3A is a schematic view of a keyboard pattern according to an embodiment of the present invention.

FIG. 3B is a schematic view of a keyboard pattern according to an embodiment of the present invention.

FIG. 4 is a flow chart of a method for inputting different language characters based on a virtual keyboard according to the present invention.

### DETAILED DESCRIPTION OF THE INVENTION

The present invention will be apparent from the following detailed description, which proceeds with reference to the accompanying drawings, wherein the same references relate to the same elements.

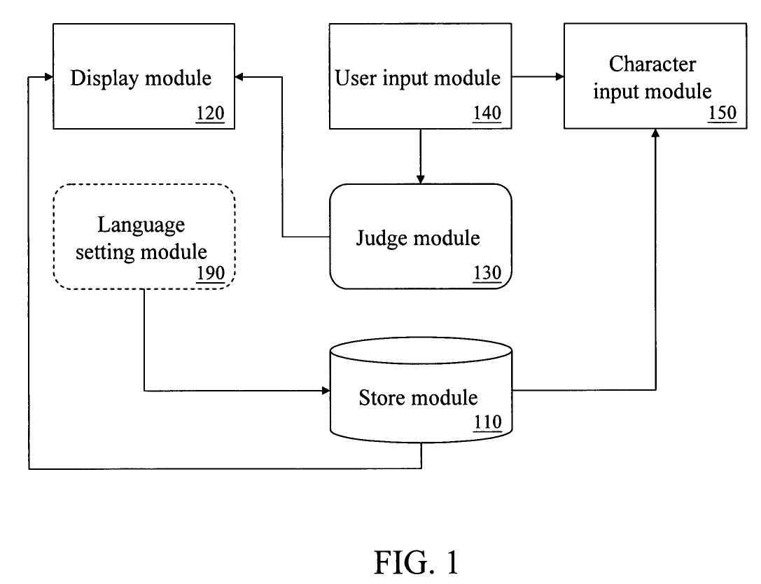

The system operation of the present invention is illustrated first with FIG. 1, which is an architecture diagram of a system for inputting different language characters based on a virtual keyboard according to the present invention. As shown, the present system includes a store module 110, a display module 120, a judge module 130, a user input module 140, and a character input module 150.

The store module 110 is responsible for storing characters belonging to a second language, and for storing character codes corresponding to various characters of the second language respectively.

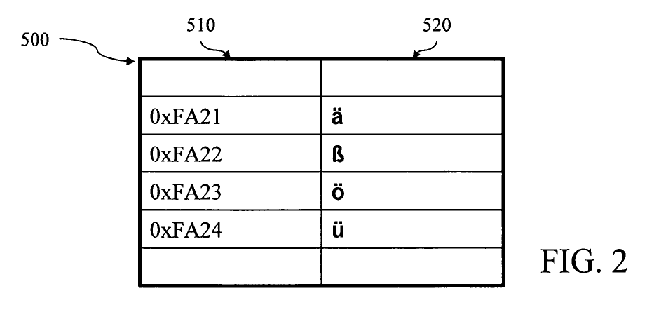

The above characters are characters that can not be input by an input method for a first language, for example, phonetic symbols such as “P, X, E” used for representing pronunciations in English, phonetic symbols such as “ [symbol] ” used for representing spellings in traditional Chinese, and text symbols in non-English languages (for example, “ [symbol] ” in Japanese, “ä, β” in German, and so on), but the present invention is not so limited. Generally, the store module 110 stores characters in form of patterns, as in a character code index table 500 shown in FIG. 2, characters in character columns 520 are stored in the store module 110 in form of patterns.

The above characters are usually stored in the store module 110 as patterns of characters and character codes before a user uses the present invention, enabling the characters be stored as corresponding character codes when a device for performing the present invention is to store a file containing the above characters, without storing as a string of specific texts. Generally, the character codes are codes that using Unicode, for example, as shown in the character code index table 500 in FIG. 2, the character code for German character “ä” is “0xFA21”.

The store module 110 may further store positions where the various characters are displayed on a virtual keyboard by the display module 120. The positions of various characters on the virtual keyboard are usually defined in a file that records the characters, and are stored onto the store module 110 while a user copies or installs the characters.

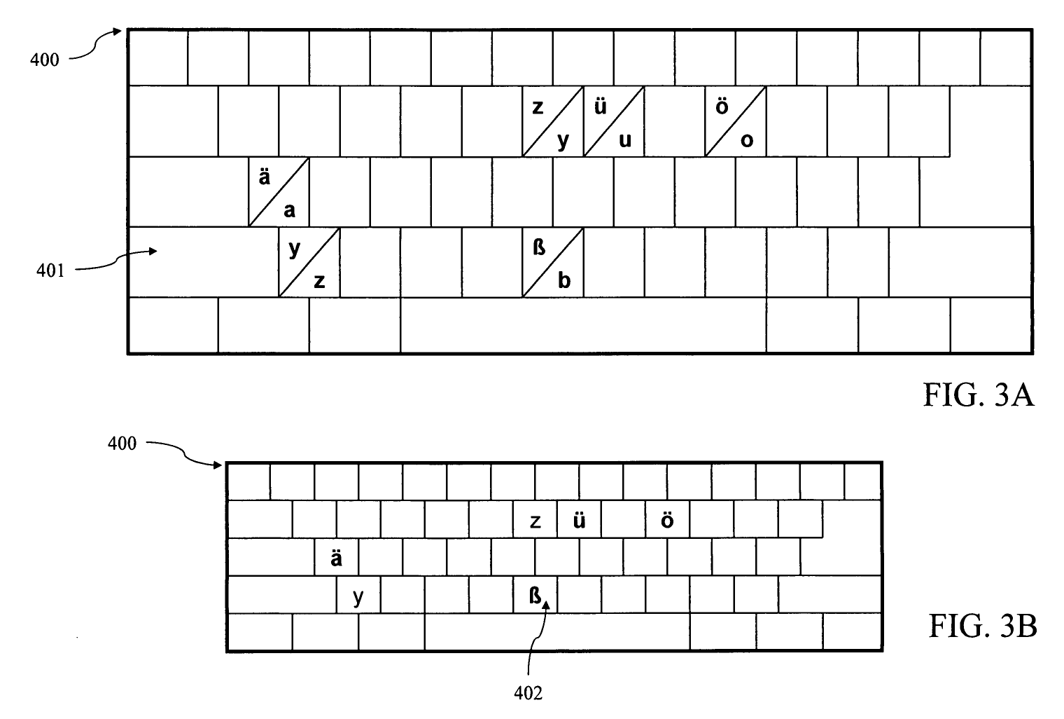

The display module 120 is responsible for displaying a virtual keyboard providing for a user to input characters belonging to a second language. The virtual keyboard contains at least one key, and on each key, there is a corresponding character. If the store module 110 stores therein the positions where the characters are to be displayed, the display module 120 displays various characters on the virtual keyboard based on the positions of various characters. Generally, the display module 120 may display the virtual keyboard in a shape similar to the appearance of an input module of the device for performing the present invention. If the input module is a computer keyboard, the display module 120 displays a keyboard pattern 400 as shown in FIG. 3A or 3B to represent the virtual keyboard, but the present invention is not so limited, and may also arrange the keys in an array or a straight line to represent the virtual keyboard.

The display module 120 reads out the patterns of characters from the character columns 520 based on the character codes in character code columns 510 by way of indexes, in the character code index table 500 stored in the store module 110, so as to display the characters on the virtual keyboard. A target language to which the characters displayed on the virtual keyboard belong is determined based on a judge result of the judge module 130.

The display module 120 can display, besides the characters of the second language on the virtual keyboard, the corresponding characters of the first language around the characters of the second language, thereby prompting the user to input the characters of the second language by inputting the characters of the first language. The virtual keyboard as shown in FIG. 3 displays, besides the characters of German (the second language), the characters of English (the first language) in right-bottom angle of the same key, in this way, the user may know that pressing the key “a” on the computer keyboard can input the German character “ä”.

The judge module 130 is responsible for judging the target language is what language based on the set of a language setting parameter after the user input module 140 receives a trigger signal, when it is judged that the target language is a second language, the judge module 130 reads the character codes belongs to the second language in the store module 110, so that the display module 120 can display the characters belonging to the second language in the virtual keyboard displayed by the display module 120 based on the character codes.

The above trigger signal is an input signal produced by the user clicking a specific icon in a window produced by the present invention, or an input signal produced by the user pressing a key on a device for performing the present invention, but the trigger signal mentioned in the present invention is not so limited, any way that can judge that a user wants to use the virtual keyboard provided by the present invention to perform character input can be used by the present invention.

The above language setting parameter is used to define a language of the characters displayed on a virtual keyboard when the virtual keyboard is displayed. When a user installs a second language in a device for performing the present invention, the language setting parameter defines the language of the characters on the virtual keyboard as the second language when the virtual keyboard is displayed.

The user input module 140 is responsible for receiving a trigger signal produced by a user performing an input behavior, and is responsible for providing for the user to perform the behavior of inputting characters belonging to a second language based on the virtual keyboard displayed by the display module 120. The user may click directly specific keys on the virtual keyboard through input devices such as a touch pen or a mouse, so as to input the characters displayed on the specific keys. If the display module 120 displays on each key of the virtual keyboard, besides the characters of the second language, the characters of the first language around the characters of the second language, for example, as shown in FIG. 3, the display module 120 displays the characters of the first language on the right-bottom angle of the characters of the second language, the user may input the characters of the second language in the same key by inputting the characters of the first language; if the virtual keyboard displayed by the display module 120 has an appearance similar to that of the input module of a device for performing the present invention, the user may input a character displayed on a corresponding specific key of the virtual keyboard by pressing a specific key on the input module based on similar appearance and the key arrangement on the virtual keyboard after making the keys on the virtual keyboard to correspond in order with the input module of the device for performing the present invention. For example, when the input module is a computer keyboard, the virtual keyboard displayed by the display module 120 may be a keyboard pattern 400 having an appearance substantially the same with that of the computer keyboard, as shown in FIG. 3B, enabling the user to establish correspondence with the arrangement positions of the keys on the computer keyboard based on the key arrangement positions on the keyboard pattern 400, whereby each key on the keyboard pattern 400 is made to correspond with each key on the computer keyboard respectively. When the user wants to input a character “β”, because the character “β” is displayed on the key 402 which is at the fourth column and the sixth row on the keyboard pattern 400, the user only needs to press the key “b” which is similarly at the fourth column and the sixth row as the key 402 on the computer keyboard to input the character “β”.

The character input module 150 is responsible for inputting a character code of a character input by a user to a target application when the user input the character through the user input module 140.

Moreover, the present invention further includes a language setting module 190 responsible for detecting a second language stored in the store module 110. When the language setting module 190 detects that more than one second language is stored in the store module 110, the language setting module 190 sets a language setting parameter, the set language setting parameter can be used to define that the second language which is first displayed on the virtual keyboard is the second language preset by the system, the second language set by a user by herself/himself, or the second language set dynamically based on the conditions such as frequency/times/word number/use time by which the user inputs each languages.

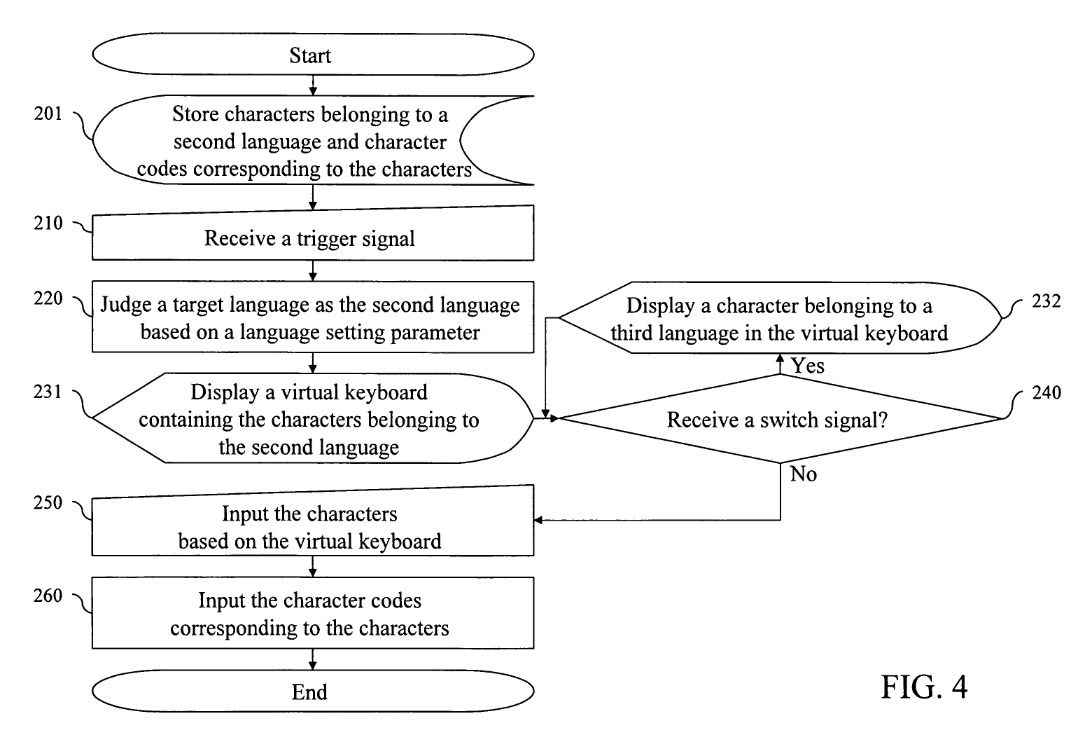

Then, the operation system and method are explained with an embodiment. Referring to FIG. 4, a flow chart of a method for inputting different language characters based on a virtual keyboard according to the present invention is shown. In the embodiment, it is assumed that the device that a user uses is a computer, and the input methods installed on the computer are Chinese and English (the first language).

Before the user wants to use the present invention to input German (the second language), the user needs to store characters of German into the store module 110 first (step 201). In the embodiment, it is assumed that the German characters such as “ä”, “β”, “ö”, and “ü” are stored in the store module 110 when the user installs a German dictionary file to a software for performing the present invention. If the dictionary file installed by the user also includes the display positions of the above character on the virtual keyboard, the positions of various characters on the virtual keyboard are also stored into the store module 110.

When the user needs to input the German character “ä” during the course of inputting English to a text edit software, the display module 120 may display an icon displaying the virtual keyboard in an interface produced by the present invention, the user may click the icon to input a trigger signal with an input device such as a mouse through an input interface provided by the user input module 140, in this way, the user input module 140 receives the trigger signal produced by the user (step 210), but the method for providing for a user to input a trigger signal according to the present invention is not so limited, for example, the user input module 140 may also provide for the user to press simultaneously the keys such as “Ctrl”, “Alt”, and “K” on the computer keyboard to input a trigger signal.

After the user input module 140 receives the trigger signal (step 210), the judge module 130 judges the target language to be displayed on the virtual keyboard based on the language setting parameter (step 220). Because the user has only installed German, the store module 110 stores therein only one second language, i.e., German. Therefore, the target language defined by the language setting parameter is German (the second language), and the judge module 130 judges that the target language is German. Subsequently, the display module 120 reads German characters from the store module 110, and displays on the displayed virtual keyboard the German characters “ä”, “β”, “ö” and “ü”, and so on (step 231). In the embodiment, the input module of the computer for performing the present invention is the computer keyboard, therefore, it is assumed that the display module 120 exhibits the virtual keyboard as the keyboard pattern 400 which is similar to the computer keyboard as shown in FIG. 3A, enabling the user to make each key on the virtual keyboard to correspond with the keys on which there printed the same character on the computer keyboard based on the characters of the first language displayed on the keys on the virtual keyboard.

Moreover, if the store module 110 also stores the display positions for various characters, for example, the display position for character “ä” is the key “a” on the computer keyboard, the display position for character “β” is the key “b” on the computer keyboard, the display position for character “ö” is the key “o” on the computer keyboard, and the display position for character “ü” is the key “u” on the computer keyboard, the positions of the above characters to be displayed on the keyboard pattern 400 by the display module 120 will be as shown in FIG. 3A.

After the display module 120 displays the virtual keyboard containing the German characters (step 231), the user input module 140 provides for the user to input the characters on the virtual keyboard based on the virtual keyboard (step 250). The user may press the key “a” on the computer keyboard, the user input module 140 produces an input signal for the character “ä” based on the correspondence of the key “a” with the key which displays the character “ä” on the virtual keyboard, but the present invention is not so limited. For example, the user input module 140 may also provide for the user to produce the input signal by clicking the character “ä” on the keyboard pattern 400 using an input device such as mouse.

After the user input module 140 provides for the user to input the characters based on the virtual keyboard (step 250), the character input module 150 reads the character code “0xFA21” and the image of the character “ä” in the character code index table 500 stored in the store module 110 based on the input signal for inputting the character “ä”, and inputs to a text edit software in which the user inputs English (step 260), thereby completing the input of the German character, enabling the text edit software to store the character “ä” with the character code “0xFA21”, and display the character “ä” in an edit panel with the image of the character “ä”.

In the above embodiment, if the user also needs to input English phonetic symbols, the user also needs to store a second language containing English phonetic symbols into the store module 110 (step 201). After the user input module 140 receives the trigger signal produced by the user (step 210), the judge module 130 judges the target language based on the language setting parameter (step 220). Because there installed two second languages (German and English) on the computer for performing the present invention, if the present invention includes the language setting module 190, the language setting module 190 may detect that there are two second languages, German and English, stored in the store module 110, the language setting module 190 may set the target language defined by the language setting parameter as the newly installed English, and may also not change the target language defined by the language setting parameter, and may further adjusts the target language defined by the language setting parameter to be German or English along with the frequency/times by which the user uses the two second languages German and English, but the present invention is not so limited. It is assumed that the target language at this time defined by the language setting parameter is still German, then the judge module 130 judges that the target language is German.

Then, the display module 120 displays the virtual keyboard containing the German characters (step 231). Because the user wants to input English phonetic symbols, the user may click a switch key 401 on the keyboard pattern 400, or press a key corresponding to the switch key 401 to produce a switch signal. After the user input module 140 receives the switch signal produced by an input behavior of the user (step 240), the display module 120 switches to display English phonetic symbols from German characters on the virtual keyboard (step 232), enabling the user to input English phonetic symbols on the virtual keyboard to the text edit software based on the virtual keyboard containing the phonetic symbols displayed by the display module 120 and through the user input module 140 (steps 250, 260).

To sum up, it can be known that the difference of the present invention with prior art lies in that, the present invention displays a virtual keyboard containing characters of a second language after receiving a trigger signal produced by an input behavior of a user in an input environment for a first language, and provides for the user to input characters of the second language based on the virtual keyboard. With such a technical solution, a problem existed in the prior art that it is not possible to input characters of other languages in the input environment for the first language is solved, thereby achieving a technical effect of enabling the user to input characters of other languages rapidly.

Furthermore, the method for inputting different language characters based on a virtual keyboard of the present invention can be implemented in a hardware, software, or a combination of a software with a hardware, and may also be implemented in a computer system with a centralized manner or implemented with a distributed manner in which different elements are distributed in several interconnected computer systems.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for inputting different language characters based on a virtual keyboard, for use in an environment for inputting a first language, the method comprising:
storing at least one character belonging to a second language and various character codes corresponding to the various characters respectively;
judging a target language as the second language based on a language setting parameter after receiving a trigger signal;
displaying a virtual keyboard containing the at least one character belonging to the second language;
inputting the character based on the virtual keyboard; and
inputting the character code corresponding to the character.

2. The method for inputting different language characters based on a virtual keyboard according to claim 1, wherein, the method further comprises switching to display the at least one character belonging to a third language in the virtual keyboard after it is judged that a switch signal is received.

3. The method for inputting different language characters based on a virtual keyboard according to claim 1, wherein, the storing the at least one character belonging to a second language and the various character codes corresponding to the various characters respectively further comprises storing a display position of the character in the virtual keyboard.

4. The method for inputting different language characters based on a virtual keyboard according to claim 1, wherein, the inputting the character based on the virtual keyboard is by clicking the character in the virtual keyboard or by pressing on an input device a key corresponding to the character in the virtual keyboard.

5. A system for inputting different language characters based on a virtual keyboard, for use in an environment for inputting a first language, the system comprising:
a store module, adapted to store at least one character and various character codes corresponding to the various characters respectively, wherein, the character belongs to a second language;
a user input module, adapted to receive a trigger signal input by a user;
a judge module, adapted to judge a target language as the second language based on a language setting parameter after the user input module receives the trigger signal;
a display module, adapted to display a virtual keyboard containing the at least one character for the user input module to provide for the user to input the character based on the virtual keyboard; and
a character input module, adapted to input the character code corresponding to the character.

6. The system for inputting different language characters based on a virtual keyboard according to claim 5, wherein, the character is a letter of the second language or a phonetic symbol of the second language.

7. The system for inputting different language characters based on a virtual keyboard according to claim 5, wherein, the user input module is further adapted to receive a switch signal input by the user, the display module is further adapted to switch to display the at least one character belonging to a third language in the virtual keyboard based on the switch signal.

8. The system for inputting different language characters based on a virtual keyboard according to claim 5, wherein, the store module is further adapted to store a display position of the character in the virtual keyboard, the display module displays the character in the virtual keyboard based on the display position.

9. The system for inputting different language characters based on a virtual keyboard according to claim 5, wherein, the user input module provides for the user to click the character in the virtual keyboard or provide for the user to press on an input device a key corresponding to the character in the virtual keyboard, thereby providing for the user to input the character based on the virtual keyboard.

10. The system for inputting different language characters based on a virtual keyboard according to claim 5, wherein, the system further comprises a language setting module adapted to set a language setting parameter, wherein, the language setting parameter defines the target language as the second language.
